(19) United States
(12) Patent Application Publication
(10) Pub. No.: US 2018/0093857 A1
(43) Pub. Date: Apr. 5, 2018

(54) OPTIMIZED OCCUPANT EVACUATION OPERATION BY UTILIZING REMAINING CAPACITY FOR MULTI-COMPARTMENT ELEVATORS

(71) Applicant: Otis Elevator Company, Farmington, CT (US)

(72) Inventors: David M. Hughes, East Hampton, CT (US); James M. Collins, Burlington, CT (US); Jannah A. Stanley, Portland, CT (US); Paul A. Stranieri, Bristol, CT (US); Ronnie E. Thebeau, Haddam, CT (US)

(21) Appl. No.: 15/281,167

(22) Filed: Sep. 30, 2016

(51) Int. Cl. B66B 5/02; B66B 1/28; B66B 1/24

(52) U.S. Cl. CPC B66B 5/021; B66B 1/28; B66B 9/00; B66B 1/2433; B66B 1/2408

(57) ABSTRACT

A method of operating an elevator system includes: receiving an evacuation call from a first evacuation floor; moving a first compartment of a multi-compartment elevator car to the first evacuation floor; opening a first door of the first compartment when the first compartment arrives at the first evacuation floor; monitoring, using a first sensor system, a remaining capacity within the first compartment; and closing the first door when at least one of a first selected period of time has passed and the remaining capacity within the first compartment is equal to a first selected remaining capacity.

### BACKGROUND

The subject matter disclosed herein relates generally to the field of elevator systems, and specifically to a method and apparatus for operating an elevator system in a building evacuation.

Commonly, during an evacuation procedure occupants of a building are instructed to take the stairs and avoid the elevator systems. An efficient method of incorporating the elevators into overall evacuation procedures is desired.

### BRIEF SUMMARY

According to one embodiment, a method of operating an elevator system is provided. The method includes receiving an evacuation call from a first evacuation floor; moving a first compartment of a multi-compartment elevator car to the first evacuation floor; opening a first door of the first compartment when the first compartment arrives at the first evacuation floor; monitoring, using a first sensor system, a remaining capacity within the first compartment; and closing the first door when at least one of a first selected period of time has passed and the remaining capacity within the first compartment is equal to a first selected remaining capacity.

In addition to one or more of the features described above, or as an alternative, further embodiments of the method may include: moving a second compartment of the multi-compartment elevator car to the first evacuation floor when the remaining capacity within the first compartment is equal to about zero; opening a second door of the second compartment when the second compartment arrives at the first evacuation floor; monitoring, using a second sensor system, a remaining capacity within the second compartment; and closing the second door when at least one of a second selected period of time has passed and the remaining capacity within the second compartment is equal to a second selected remaining capacity.

In addition to one or more of the features described above, or as an alternative, further embodiments of the method may include: receiving an evacuation call from a second evacuation floor; and moving the second compartment to the second evacuation floor when the second door has closed and the remaining capacity within the second compartment is greater than zero.

In addition to one or more of the features described above, or as an alternative, further embodiments of the method may include: receiving an elevator call from a padding floor; and moving the second compartment to the padding floor when the second door has closed and the remaining capacity within the second compartment is greater than zero; wherein the padding floor is within a selected number of floors away from the first evacuation floor.

In addition to one or more of the features described above, or as an alternative, further embodiments of the method may include that at least one of the selected remaining capacity and the first selected period of time is determined in response to the urgency of the evacuation situation.

In addition to one or more of the features described above, or as an alternative, further embodiments of the method may include: receiving an evacuation call from a second evacuation floor; and moving the first compartment to the second evacuation floor when the first door has closed and the remaining capacity within the first compartment is greater than zero.

In addition to one or more of the features described above, or as an alternative, further embodiments of the method may include: receiving an evacuation elevator call from a padding floor; and moving the first compartment to the padding floor when the first door has closed and the remaining capacity within the first compartment is greater than zero.

In addition to one or more of the features described above, or as an alternative, further embodiments of the method may include: receiving an evacuation call from a second evacuation floor; and moving at least one of the first compartment and the second compartment to the second evacuation floor when the first door has closed; wherein the compartment moved to the second evacuation floor has a remaining capacity greater than zero.

In addition to one or more of the features described above, or as an alternative, further embodiments of the method may include: receiving an evacuation elevator call from a padding floor; and moving at least one of the first compartment and the second compartment to the padding floor when the first door has closed; wherein the compartment moved to the padding floor has a remaining capacity greater than zero.

According to another embodiment, a controller of an elevator system is provided. The controller including: a processor; and a memory comprising computer-executable instructions that, when executed by the processor, cause the processor to perform operations. The operations including: receiving an evacuation call from a first evacuation floor; moving a first compartment of a multi-compartment elevator car to the first evacuation floor; opening a first door of the first compartment when the first compartment arrives at the first evacuation floor; monitoring, using a first sensor system, a remaining capacity within the first compartment; and closing the first door when at least one of a first selected period of time has passed and the remaining capacity within the first compartment is equal to a first selected remaining capacity.

In addition to one or more of the features described above, or as an alternative, further embodiments of the controller may include that the operations further include: moving a second compartment of the multi-compartment elevator car to the first evacuation floor when the remaining capacity within the first compartment is equal to about zero; opening a second door of the second compartment when the second compartment arrives at the first evacuation floor; monitoring, using a second sensor system, a remaining capacity within the second compartment; and closing the second door when at least one of a second selected period of time has passed and the remaining capacity within the second compartment is equal to a second selected remaining capacity.

In addition to one or more of the features described above, or as an alternative, further embodiments of the controller may include that the operations further include: receiving an evacuation call from a second evacuation floor; and moving the second compartment to the second evacuation floor when the second door has closed and the remaining capacity within the second compartment is greater than zero.

In addition to one or more of the features described above, or as an alternative, further embodiments of the controller may include that the operations further include: receiving an elevator call from a padding floor; and moving the second compartment to the padding floor when the second door has closed and the remaining capacity within the second compartment is greater than zero; wherein the padding floor is within a selected number of floors away from the first evacuation floor.

In addition to one or more of the features described above, or as an alternative, further embodiments of the controller may include that at least one of the selected remaining capacity and the first selected period of time is determined in response to the urgency of the evacuation situation.

In addition to one or more of the features described above, or as an alternative, further embodiments of the controller may include that the operations further include: receiving an evacuation call from a second evacuation floor; and moving the first compartment to the second evacuation floor when the first door has closed and the remaining capacity within the first compartment is greater than zero.

In addition to one or more of the features described above, or as an alternative, further embodiments of the controller may include that the operations further include: receiving an evacuation elevator call from a padding floor; and moving the first compartment to the padding floor when the first door has closed and the remaining capacity within the first compartment is greater than zero.

In addition to one or more of the features described above, or as an alternative, further embodiments of the controller may include that the operations further include: receiving an evacuation call from a second evacuation floor; and moving at least one of the first compartment and the second compartment to the second evacuation floor when the first door has closed; wherein the compartment moved to the second evacuation floor has a remaining capacity greater than zero.

In addition to one or more of the features described above, or as an alternative, further embodiments of the controller may include that the operations further include: receiving an evacuation elevator call from a padding floor; and moving at least one of the first compartment and the second compartment to the padding floor when the first door has closed; wherein the compartment moved to the padding floor has a remaining capacity greater than zero.

According to another embodiment, a computer program product tangibly embodied on a computer readable medium is provided. The computer program product including instructions that, when executed by a processor, cause the processor to perform operations including: receiving an evacuation call from a first evacuation floor; moving a first compartment of a multi-compartment elevator car to the first evacuation floor; opening a first door of the first compartment when the first compartment arrives at the first evacuation floor; monitoring, using a first sensor system, a remaining capacity within the first compartment; and closing the first door when at least one of a first selected period of time has passed and the remaining capacity within the first compartment is equal to a first selected remaining capacity.

In addition to one or more of the features described above, or as an alternative, further embodiments of the computer program may include that the operations further include: receiving an evacuation call from a second evacuation floor; and moving at least one of the first compartment and the second compartment to the second evacuation floor when the first door has closed; wherein the compartment moved to the second evacuation floor has a remaining capacity greater than zero.

Technical effects of embodiments of the present disclosure include a control system to control the operation of an elevator system by sending the multi-compartment elevator car to a first evacuation floor when an evacuation procedure is initiated and reallocating the multi-compartment elevator car to a second evacuation floor or a padding floor if one of the compartments of the multi-compartment elevator car has remaining capacity.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several FIGURES:

FIG. 1 illustrates a schematic view of an elevator system having a multi-compartment elevator car, in accordance with an embodiment of the disclosure;

FIG. 2 illustrates a schematic view of a building incorporating the elevator system of FIG. 1, in accordance with an embodiment of the disclosure; and

FIG. 3 is a flow chart of method of operating the elevator system of FIG. 1, in accordance with an embodiment of the disclosure; and

FIG. 4 is a flow chart of method of operating the elevator system of FIG. 1, in accordance with an embodiment of the disclosure.

### DETAILED DESCRIPTION

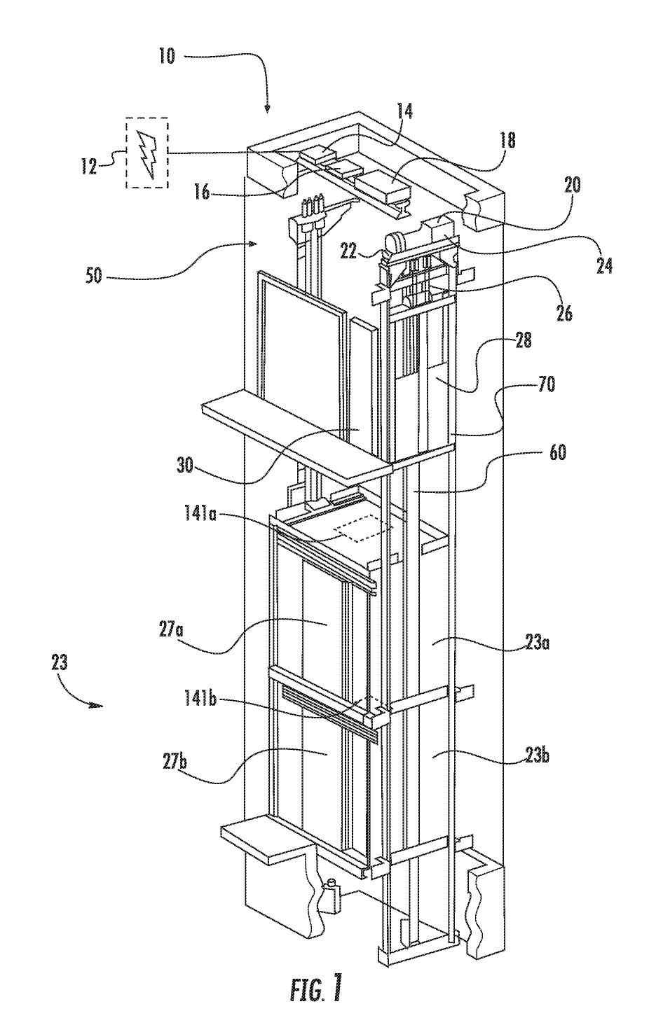

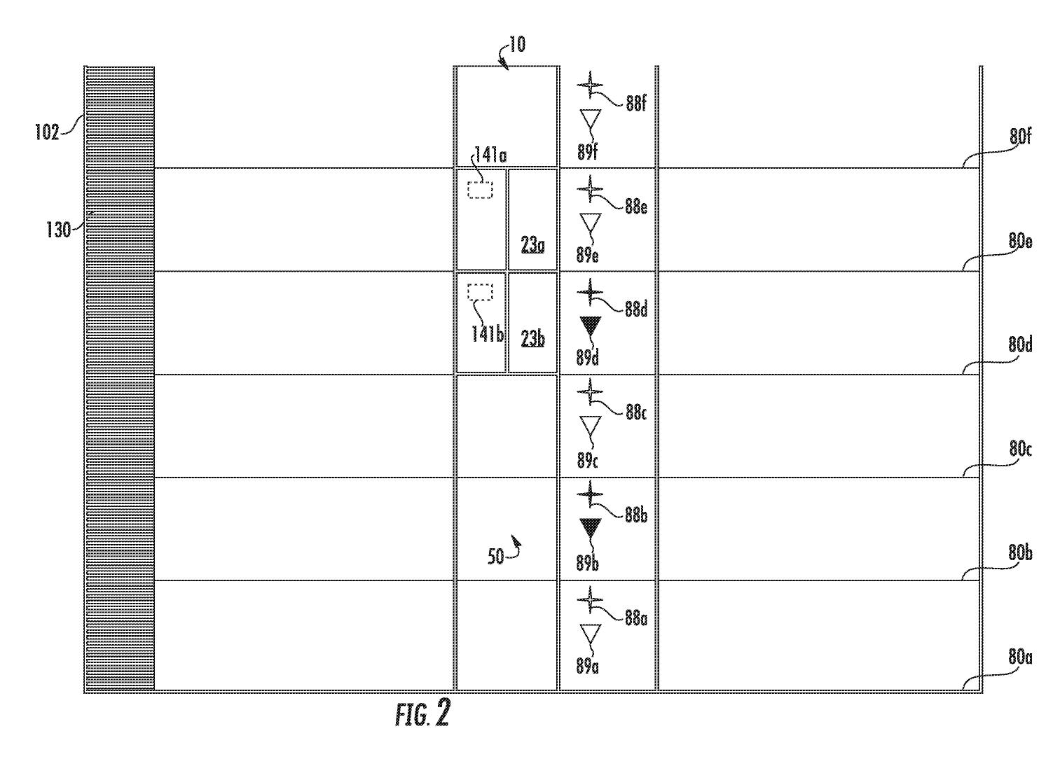

FIG. 1 shows a schematic view of an elevator system 10 having a multi-compartment elevator car 23, in accordance with an embodiment of the disclosure. FIG. 2 shows schematic view of a building 102 incorporating the elevator system 10 of FIG. 1, in accordance with an embodiment of the disclosure. With reference to FIG. 1, the elevator system 10 includes a multi-compartment elevator car 23 configured to move vertically upward and downward within a hoistway 50 along a plurality of car guide rails 60. As seen in FIG. 1, the multi-compartment elevator car 23 includes a first compartment 23a and a second compartment 23b. The first compartment 23a includes a first door 27a and the second compartment 23b includes a second door 27b. The doors 27a, 27b for each compartment 23a, 23b open and close, allowing passengers to enter and exit each compartment 23a, 23b of the multi-compartment elevator car 23. The elevator system 10 also includes a counterweight 28 operably connected to the multi-compartment elevator car 23 via a pulley system 26. The counterweight 28 is configured to move vertically upward and downward within the hoistway 50. The counterweight 28 moves in a direction generally opposite the movement of the multi-compartment elevator car 23, as is known in conventional elevator assemblies. Movement of the counterweight 28 is guided by counterweight guide rails 70 mounted within the hoistway 50.

The elevator system 10 also includes a power source 12. The power is provided from the power source 12 to a switch panel 14, which may include circuit breakers, meters, etc. From the switch panel 14, the power may be provided directly to the drive unit 20 through the controller 30 or to an internal power source charger 16, which converts AC power to direct current (DC) power to charge an internal power source 18 that requires charging. For instance, an internal power source 18 that requires charging may be a battery, capacitor, or any other type of power storage device known to one of ordinary skill in the art. Alternatively, the internal power source 18 may not require charging from the external power source 12 and may be a device such as, for example a gas powered generator, solar cells, hydroelectric generator, wind turbine generator or similar power generation device. The internal power source 18 may power various components of the elevator system 10 when an external power source is unavailable. The drive unit 20 drives a machine 22 to impart motion to the multi-compartment elevator car 23 via a traction sheave of the machine 22. The machine 22 also includes a brake 24 that can be activated to stop the machine 22 and multi-compartment elevator car 23. As will be appreciated by those of skill in the art, FIG. 1 depicts a machine room-less elevator system 10, however the embodiments disclosed herein may be incorporated with other elevator systems that are not machine room-less or that include any other known elevator configuration. In addition, elevator systems having more than one independently operating elevator car in each elevator shaft and/or ropeless elevator systems may also be used. In one embodiment, the elevator car may have three or more compartments.

The controller 30 is responsible for controlling the operation of the elevator system 10. The controller 30 may also determine a mode (motoring, regenerative, near balance) of the multi-compartment elevator car 23. The controller 30 may use the car direction and the weight distribution between the multi-compartment elevator car 23 and the counterweight 28 to determine the mode of the elevator car 23. The controller 30 may adjust the velocity of the multi-compartment elevator car 23 to reach a target floor. The controller 30 may include a processor and an associated memory. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The elevator system 10 may also include a sensor system 141a, 141b configured to detect a remaining capacity in a particular compartment of the multi-compartment elevator car 23. The remaining capacity is indicative of the number of additional passengers that may board the elevator car 23 and allows the controller 30 to determine how much space is left in the elevator compartment 23a, 23b. For instance, if the remaining capacity is equal to about zero there is no space left in the elevator compartment 23a, 23b to accept more passengers, whereas if the remaining capacity is greater than zero there may be space to accept more passengers in the elevator compartment 23a, 23b. The first compartment 23a includes a first sensor system 141a and the second compartment 23b includes a second sensor system 141b. Each sensor system 141a and 141b is in operative communication with the controller 30. The sensor systems 141a, 141b may use a variety of sensing mechanisms such as, for example, a visual detection device, a weight detection device, a laser detection device, a door reversal monitoring device, a thermal image detection device, and a depth detection device. The visual detection device may be a camera that utilizes visual recognition to identify individual passengers and objects in the elevator compartment 23a, 23b and then determine remaining capacity. The weight detection device may be a scale to sense the amount of weight in an elevator compartment 23a, 23b and then determine the remaining capacity from the weight sensed. The laser detection device may detect how many passengers walk through a laser beam to determine the remaining capacity in the elevator compartment 23a, 23b. Similarly, a door reversal monitoring device also detects passengers entering the car so as not to close the elevator door on a passenger and thus may be used to determine the remaining capacity. The thermal detection device may be an infrared or other heat sensing camera that utilizes detected temperature to identify individual passengers and objects in the elevator compartment 23a, 23b and then determine remaining capacity. The depth detection device may be a 2-D, 3-D or other depth/distance detecting camera that utilizes detected distance to an object and/or passenger to determine remaining capacity. As may be appreciated by one of skill in the art, in addition to the stated methods, additional methods may exist to sense remaining capacity and one or any combination of these methods may be used to determine remaining capacity in the elevator car.

Advantageously, determining the remaining capacity of each compartment 23a, 23b of the multi-compartment elevator car 23 may determine whether to send the multi-compartment elevator car 23 to another floor 80a-80f or the discharge floor (FIG. 2). A discharge floor 82 may be a floor 80a-80f where occupants (i.e. passengers) can evacuate the building 102 (FIG. 2). For example, in one embodiment the discharge floor may be a ground floor. In the example of FIG. 2, the discharge floor may be floor 80a.

FIG. 2 shows a building 102 incorporating an elevator system 10 having a multi-compartment elevator car 23. The building 102 includes multiple floors 80a-80f, each floor 80a-80f having an elevator call button 89a-89f and an evacuation alarm 88a-88f. The elevator call button 89a-89f sends an elevator call to the controller 30. The elevator call button 89a-89f may be a push button and/or a touch screen and may be activated manually or automatically. For example, the elevator call button 89a-89f may be activated by a building occupant pushing the elevator call button 89a-89f. The elevator call button 89a-89f may also be activated voice recognition or a passenger detection mechanism in the hallway, such as, for example a weight sensing device, a visual recognition device, and a laser detection device. The evacuation alarm 88a-88f may be activated or deactivated either manually or automatically through a fire alarm system. If the evacuation alarm 88a-88b is activated, an evacuation call is sent to the controller 30 indicating the respective floor 80a-80f where the evacuation alarm 88a-88f was activated. In the example of FIG. 2, an evacuation alarm 88d is activated first on floor 88d and then a second evacuation alarm 88b is later activated on floor 80b. The evacuation alarm 88a, 88c, 88e, 88f is not activated on floors 80a, 80c, 80e, and 80f. The first floor to activate an evacuation alarm 88a-88f may be known as the first evacuation floor. In the example of FIG. 2, the first evacuation floor is floor 80d. The second evacuation floor to activate an evacuation alarm may be known as the second evacuation floor and so on.

The first evacuation floor may be surrounded by padding floors, which are floors that are considered at increased risk due to their proximity to the evacuation floor and thus should also be evacuated. In the example of FIG. 2, the padding floors for the first evacuation floor are floors 80b, 80c, 80e, and 80f. The padding floors may include floors that are a selected number of floors away from the first evacuation floor. In one embodiment, the padding floors may include any number of floors on either side of an evacuation floor. For example, in one embodiment, the padding floors may include the floor immediately below the evacuation floor and the three floors immediately above the evacuation floor. In another example, in one embodiment, the padding floors may include the two floors above the first evacuation floor and the two floors below the first evacuation floor. The first evacuation floor and the padding floors make up an evacuation zone. In the example of FIG. 2, the evacuation zone is composed of floors 80b-80f.

In one embodiment, there may be more than one evacuation floor. For example, after the first evacuation floor activates an evacuation alarm, a second evacuation floor may also activate an evacuation alarm. In the example of FIG. 2, the second evacuation floor is floor 80b. In one embodiment, there may be any number of evacuation floors. Evacuation floors may be evacuated in the order that the evacuation call is received. Padding floors of the first evacuation floor may be evacuated before the second evacuation floor. In one embodiment, all evacuation floors may be evacuated first, followed by padding floors associated with each evacuation floor in the order in which the corresponding evacuation call was placed. Although in the embodiment of FIG. 2 the second evacuation floor is contiguous to the padding floors of the first evacuation floor, the second evacuation floor and any subsequent evacuation floors may be located anywhere within the building. The building also includes a discharge floor, which is a floor where occupants can evacuate the building 102. For example, in one embodiment the discharge floor may be a ground floor. In one embodiment, the discharge floor may be any floor that permits an occupant to evacuate the building. In the example of FIG. 2, the discharge floor is floor 80a. The building may also include a stairwell 130 as seen in FIG. 2.

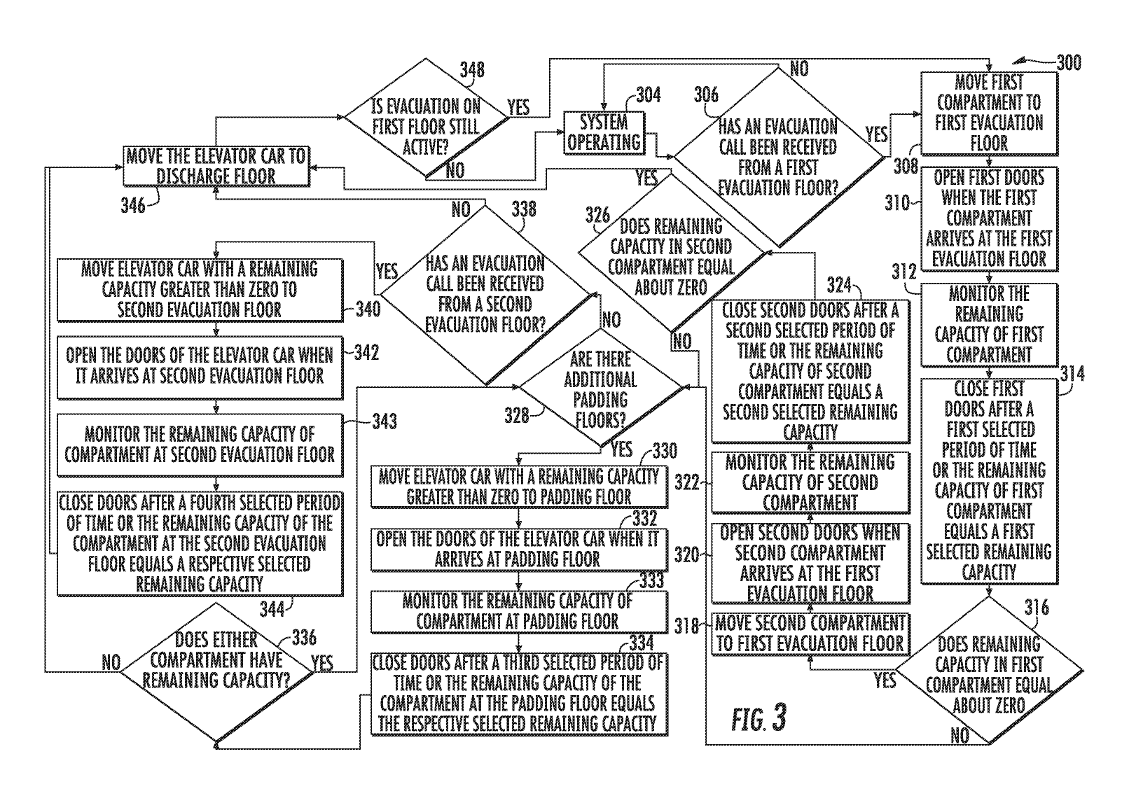

Referring now to FIG. 3, while referencing components of FIGS. 1 and 2. FIG. 3 shows a flow chart of method 300 of operating the elevator system 10 of FIG. 1, in accordance with an embodiment of the disclosure. At block 304, the elevator system 10 is under normal operation. At block 306, the controller 30 is checking whether it has received an evacuation call from a first evacuation floor. In an alternative embodiment, the controller 30 may also check whether an elevator call has been received from the first evacuation floor to ensure there are passengers on the floor before moving a compartment 23a, 23b to the first evacuation floor. At block 306, if the controller 30 has received an evacuation call from a first evacuation floor then the controller 30 moves a first compartment 23a to the first evacuation floor at block 308. At block 310, the controller 30 opens the first doors 27a of the first compartment 23a when the first compartment 23a arrives at the first evacuation floor. At block 312, the first sensor system 141a monitors the remaining capacity of the first compartment 23a. At block 314, the controller 30 will close the first doors 23a after a first selected period of time has passed or the remaining capacity of the first compartment 23a equals a first selected remaining capacity. In one embodiment, the selected remaining capacity may be 0, indicating that there is no additional room for passengers to board the first compartment 23a. In one embodiment, the selected remaining capacity may be greater than 0. In one embodiment, the selected remaining capacity may be approximately equal to 10% of the elevators rated maximum capacity. As described in detail below, the first selected remaining capacity and second selected remaining capacity may be preset using any of the above methods. In one embodiment, the selected remaining capacity may be dynamically determined in response to the urgency of the evacuation situation. For example, if there is an intense fire on the floor being evacuated, the selected remaining capacity may be increased in order to permit the elevator car 23 to leave sooner in the event that no more passengers are boarding. The selected period of time may be enough time to allow passengers to fill the remaining capacity of the respective compartment 23a, 23b, such as, for example ten seconds. The selected period of time may change in response to many factors including the remaining capacity of the respective compartment and thus there may be a first selected period of time, a second selected period of time, a third selected period of time, and so on to account for the variations the time required to load passengers at each floor. In an embodiment, each selected period of time may be equal to ten seconds. In another embodiment, each selected period of time may be greater than or less than ten seconds. In one embodiment, the selected period of time may be dynamically determined in response to the urgency of the evacuation situation. For example, if there is an intense fire on the floor being evacuated, the selected period of time may be decreased in order to permit the elevator car 23 to leave sooner in the event that no more passengers are boarding. The first compartment may have a first selected remaining capacity and the second compartment may have a second selected remaining capacity.

At block 314, if the first selected period of time has passed or the remaining capacity of the first compartment 23a equals the first selected remaining capacity then the method 300 will move to block 316 to check whether the remaining capacity is equal to about zero. For example, if the remaining capacity equals about zero then there is no room for any more passengers. At block 316, if the remaining capacity is greater than zero then the controller 30 will check if there are any padding floors at block 328. A padding floor exists if an elevator call has been received from the padding floor indicating that there are still passengers left on the padding floor. At block 316, if the remaining capacity is equal to about zero then the controller 30 moves the second compartment 23b to the first evacuation floor at block 318.

Once the second compartment 23b has arrived at the first evacuation floor, the controller 30 opens the second doors 27b of the second compartment 23b at block 320. At block 322, the second sensor system 141b monitors the remaining capacity of the second compartment 23b. At block 324, the controller 30 will close the second doors 23a after a second selected period of time has passed or the remaining capacity of the second compartment 23b equals a second selected remaining capacity.

Once the second doors 23b have closed at block 324, then at block 326 the controller 30 will check whether the remaining capacity in the second compartment 23b equals zero. At block 326, if the remaining capacity in the second compartment 23b equals zero that means that the remaining capacity of both compartments 23a, 23b now equal zero and thus the multi-compartment elevator car 23 will move to the discharge floor at block 346.

At block 326, if the remaining capacity in the second compartment 23b is greater than zero then the method 300 will move to block 328 to check whether there are any padding floors. At block 328, if there are no padding floors then the method 300 moves to block 338 to check whether a second evacuation call has been received from a second evacuation floor. In an alternative embodiment, the controller 30 may also check whether an elevator call has been received from the second evacuation floor to ensure there are passengers on the floor before moving a compartment 23a, 23b to the second evacuation floor. At block 328, if there are padding floors then the controller 30 will move a compartment 23a, 23b with a remaining capacity greater than zero to the padding floor at block 330.

Once the compartment 23a, 23b with a remaining capacity greater than zero has arrived at the padding floor, the controller 30 opens the doors 27a, 27b of the compartment 23a, 23b at block 332. At block 333, the respective sensor system 141a, 141b monitors the remaining capacity of the compartment 23, 23b at the padding floor. At block 334, the controller 30 will close the doors 27a, 27b of the compartment at the padding floor after a third selected period of time has passed or the remaining capacity of the compartment 23a, 23b at the padding floor equals the respective selected remaining capacity (i.e. first selected remaining capacity for the first compartment 23a and second selected remaining capacity for the second compartment 23b). Next at block 336, the controller 30 checks whether either compartment 23a, 23b has any remaining capacity. At block 336, if neither compartment 23a, 23b has remaining capacity, then the controller 30 will move the multi-compartment elevator car 23 to the discharge floor at block 346. At block 336, if either compartment 23a, 23b has any remaining capacity, the method 300 will move back to block 328.

At block 326, if there are no padding floors then the method 300 moves to block 338 to check whether a second evacuation call has been received from a second evacuation floor. At block 338, if a second evacuation call has not been received from a second evacuation floor, then the controller 30 will move the multi-compartment elevator car 23 to the discharge floor at block 346. At block 338, if a second evacuation call has been received from a second evacuation floor, then the controller 30 will move a compartment 23a, 23b with a remaining capacity greater than zero to the second evacuation floor at block 340.

Once the compartment 23a, 23b with a remaining capacity greater than zero has arrived at the second evacuation floor, the controller 30 opens the doors 27a, 27b of the compartment 23a, 23b at block 342. At block 343, the respective sensor system 141a, 141b monitors the remaining capacity of the compartment 23, 23b at the second evacuation floor. At block 344, the controller 30 will close the doors 27a, 27b of the compartment at the second evacuation floor after a fourth selected period of time has passed or the remaining capacity of the compartment 23a, 23b at the second evacuation floor equals the respective selected remaining capacity (i.e. first selected remaining capacity for the first compartment 23a and second selected remaining capacity for the second compartment 23b). Next at block 346, the controller 30 will move the multi-compartment elevator car 23 to the discharge floor at block 346. Once passengers have exited the multi-compartment elevator car 23 at the discharge floor, the controller will check to see whether the evacuation is still active on the first evacuation floor at block 348. At block 348, if the evacuation is not still active on the first evacuation floor then the method will return to block 304. At block 348, if the evacuation is still active on the first evacuation floor then the method will return to block 308.

While the above description has described the flow process of FIG. 3 in a particular order, it should be appreciated that unless otherwise specifically required in the attached claims that the ordering of the steps may be varied.

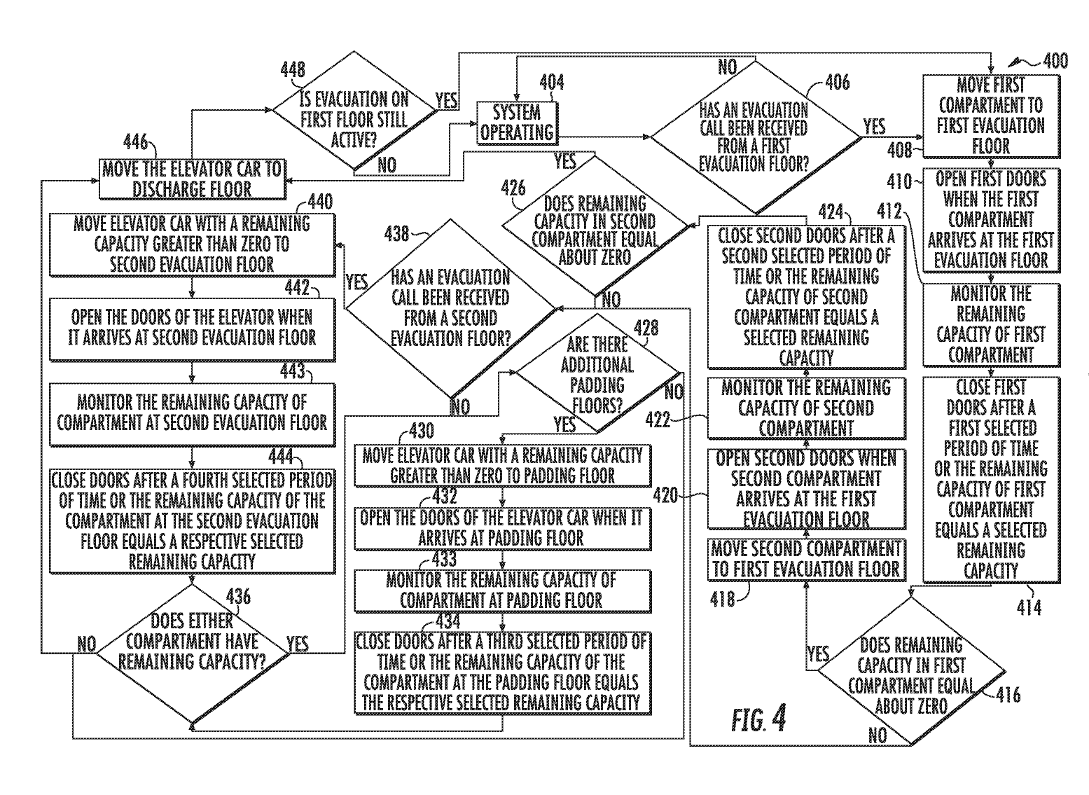

Referring now to FIG. 4, while referencing components of FIGS. 1 and 2. FIG. 4 shows a flow chart of method 400 of operating the elevator system 10 of FIG. 1, in accordance with an embodiment of the disclosure. At block 404, the elevator system 10 is under normal operation. At block 406, the controller 30 is checking whether it has received an evacuation call from a first evacuation floor. In an alternative embodiment, the controller 30 may also check whether an elevator call has been received from the first evacuation floor to ensure there are passengers on the floor before moving a compartment 23a, 23b to the first evacuation floor. At block 406, if the controller 30 has received an evacuation call from a first evacuation floor then the controller 30 moves a first compartment 23a to the first evacuation floor at block 408. At block 410, the controller 30 opens the first doors 27a of the first compartment 23a when the first compartment 23a arrives at the first evacuation floor. At block 412, the first sensor system 141a monitors the remaining capacity of the first compartment 23a. At block 414, the controller 30 will close the first doors 23a after a first selected period of time has passed or the remaining capacity of the first compartment 23a equals a selected remaining capacity. The selected period of time may be enough time to allow passengers to fill the remaining capacity of the respective compartment 23a, 23b, such as, for example ten seconds. The selected period of time may change in response to many factors including the remaining capacity of the respective compartment and thus there may be a first selected period of time, a second selected period of time, a third selected period of time, and so on to account for the variations the time required to load passengers at each floor. In an embodiment, each selected period of time may be equal to ten seconds. In another embodiment, each selected period of time may be greater than or less than ten seconds. The first compartment may have a first selected remaining capacity and the second compartment may have a second selected remaining capacity.

At block 414, if the first selected period of time has passed or the remaining capacity of the first compartment 23a equals the selected remaining capacity then the method 400 will move to block 416 to check whether the remaining capacity is equal to about zero. For example, if the remaining capacity equals about zero then there is no room for any more passengers. At block 416, if the remaining capacity is greater than zero then the controller 30 will check if there are any padding floors at block 428. A padding floor exists if an elevator call has been received from the padding floor indicating that there are still passengers left on the padding floor. At block 416, if the remaining capacity is equal to about zero then the controller 30 moves the second compartment 23b to the first evacuation floor at block 418.

Once the second compartment 23b has arrived at the first evacuation floor, the controller 30 opens the second doors 27b of the second compartment 23b at block 420. At block 422, the second sensor system 141b monitors the remaining capacity of the second compartment 23b. At block 424, the controller 30 will close the second doors 23a after a second selected period of time has passed or the remaining capacity of the second compartment 23b equals a selected remaining capacity.

Once the second doors 23b have closed at block 424, then at block 426 the controller 30 will check whether the remaining capacity in the second compartment 23b equals zero. At block 426, if the remaining capacity in the second compartment 23b equals zero that means that the remaining capacity of both compartments 23a, 23b now equal zero and thus the multi-compartment elevator car 23 will move to the discharge floor at block 446. At block 426, if the remaining capacity in the second compartment 23b is greater than zero then the method 400 will move to block 428 to check whether the controller 30 has received a second evacuation call from a second evacuation floor at block 438. In an alternative embodiment, the controller 30 may also check whether an elevator call has been received from the second evacuation floor to ensure there are passengers on the floor before moving a compartment 23a, 23b to the second evacuation floor. At block 438, if a second evacuation call has not been received then the method 400 moves to block 428 to check whether there are padding floors. At block 438, if a second evacuation call has been received then the controller 30 will move a compartment 23a, 23b with a remaining capacity greater than zero to the second evacuation floor at block 440.

Once the compartment 23a, 23b with a remaining capacity greater than zero has arrived at the second evacuation floor, the controller 30 opens the doors 27a, 27b of the compartment 23a, 23b at block 442. At block 443, the respective sensor system 141a, 141b monitors the remaining capacity of the compartment 23, 23b at the second evacuation floor. At block 444, the controller 30 will close the doors 27a, 27b of the compartment at the second evacuation floor after a third selected period of time has passed or the remaining capacity of the compartment 23a, 23b at the second evacuation floor equals the respective selected remaining capacity (i.e. first selected remaining capacity for the first compartment 23a and second selected remaining capacity for the second compartment 23b). Next at block 436, the controller 30 checks whether either compartment 23a, 23b has any remaining capacity. At block 436, if neither compartment 23a, 23b has remaining capacity, then the controller 30 will move the multi-compartment elevator car 23 to the discharge floor at block 446. At block 436, if either compartment 23a, 23b has any remaining capacity, the method 400 will move to block 428 to check for padding floors.

At block 426, if there are no padding floors then the method 400 moves to block 446 and the controller sends the multi-compartment elevator car 23 to the discharge floor.

At block 428, if there are padding floors then the controller 30 will move a compartment 23a, 23b with a remaining capacity greater than zero to the padding floors at block 430. Once the compartment 23a, 23b with a remaining capacity greater than zero has arrived at the padding floor, the controller 30 opens the doors 27a, 27b of the compartment 23a, 23b at block 432. At block 433, the respective sensor system 141a, 141b monitors the remaining capacity of the compartment 23, 23b at the padding floor. At block 434, the controller 30 will close the doors 27a, 27b of the compartment at the second evacuation floor after a fourth selected period of time has passed or the remaining capacity of the compartment 23a, 23b at the padding floor equals the respective selected remaining capacity (i.e. first selected remaining capacity for the first compartment 23a and second selected remaining capacity for the second compartment 23b).

Next at block 436, the controller 30 checks whether either compartment 23a, 23b has any remaining capacity. At block 436, if neither compartment 23a, 23b has remaining capacity, then the controller 30 will move the multi-compartment elevator car 23 to the discharge floor at block 446. At block 436, if either compartment 23a, 23b has any remaining capacity, the method 400 will move back to block 428 to check for padding floors. Once the controller 30 has moved the multi-compartment elevator car 23 to the discharge floor at block 446 and passengers have exited the multi-compartment elevator car 23 at the discharge floor, the controller 30 will check to see whether the evacuation is still active on the first evacuation floor at block 448. At block 448, if the evacuation is not still active on the first evacuation floor then the method will return to block 404. At block 448, if the evacuation is still active on the first evacuation floor then the method will return to block 408.

While the above description has described the flow process of FIG. 4 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

What is claimed is:

1. A method of operating an elevator system, the method comprising:
receiving an evacuation call from a first evacuation floor;
moving a first compartment of a multi-compartment elevator car to the first evacuation floor;
opening a first door of the first compartment when the first compartment arrives at the first evacuation floor;
monitoring, using a first sensor system, a remaining capacity within the first compartment; and
closing the first door when at least one of a first selected period of time has passed and the remaining capacity within the first compartment is equal to a first selected remaining capacity.

2. The method of claim 1, further comprising:
moving a second compartment of the multi-compartment elevator car to the first evacuation floor when the remaining capacity within the first compartment is equal to about zero;
opening a second door of the second compartment when the second compartment arrives at the first evacuation floor;
monitoring, using a second sensor system, a remaining capacity within the second compartment; and
closing the second door when at least one of a second selected period of time has passed and the remaining capacity within the second compartment is equal to a second selected remaining capacity.

3. The method of claim 2, further comprising:
receiving an evacuation call from a second evacuation floor; and
moving the second compartment to the second evacuation floor when the second door has closed and the remaining capacity within the second compartment is greater than zero.

4. The method of claim 2, further comprising:
receiving an elevator call from a padding floor; and
moving the second compartment to the padding floor when the second door has closed and the remaining capacity within the second compartment is greater than zero;
wherein the padding floor is within a selected number of floors away from the first evacuation floor.

5. The method of claim 1, wherein:
at least one of the selected remaining capacity and the first selected period of time is determined in response to the urgency of the evacuation situation.

6. The method of claim 1, further comprising:
receiving an evacuation call from a second evacuation floor; and
moving the first compartment to the second evacuation floor when the first door has closed and the remaining capacity within the first compartment is greater than zero.

7. The method of claim 1, further comprising:
receiving an evacuation elevator call from a padding floor; and
moving the first compartment to the padding floor when the first door has closed and the remaining capacity within the first compartment is greater than zero.

8. The method of claim 1, further comprising:
receiving an evacuation call from a second evacuation floor; and
moving at least one of the first compartment and the second compartment to the second evacuation floor when the first door has closed;
wherein the compartment moved to the second evacuation floor has a remaining capacity greater than zero.

9. The method of claim 1, further comprising:
receiving an evacuation elevator call from a padding floor; and
moving at least one of the first compartment and the second compartment to the padding floor when the first door has closed;
wherein the compartment moved to the padding floor has a remaining capacity greater than zero.

10. A controller of an elevator system comprising:
a processor; and
a memory comprising computer-executable instructions that, when executed by the processor, cause the processor to perform operations, the operations comprising:
receiving an evacuation call from a first evacuation floor;
moving a first compartment of a multi-compartment elevator car to the first evacuation floor;
opening a first door of the first compartment when the first compartment arrives at the first evacuation floor;
monitoring, using a first sensor system, a remaining capacity within the first compartment; and
closing the first door when at least one of a first selected period of time has passed and the remaining capacity within the first compartment is equal to a first selected remaining capacity.

11. The controller of claim 10, wherein the operations further comprise:
moving a second compartment of the multi-compartment elevator car to the first evacuation floor when the remaining capacity within the first compartment is equal to about zero;
opening a second door of the second compartment when the second compartment arrives at the first evacuation floor;
monitoring, using a second sensor system, a remaining capacity within the second compartment; and
closing the second door when at least one of a second selected period of time has passed and the remaining capacity within the second compartment is equal to a second selected remaining capacity.

12. The controller of claim 11, wherein the operations further comprise:
receiving an evacuation call from a second evacuation floor; and
moving the second compartment to the second evacuation floor when the second door has closed and the remaining capacity within the second compartment is greater than zero.

13. The controller of claim 11, wherein the operations further comprise:
receiving an elevator call from a padding floor; and
moving the second compartment to the padding floor when the second door has closed and the remaining capacity within the second compartment is greater than zero;
wherein the padding floor is within a selected number of floors away from the first evacuation floor.

14. The controller of claim 10, wherein:
at least one of the selected remaining capacity and the first selected period of time is determined in response to the urgency of the evacuation situation.

15. The controller of claim 10, wherein the operations further comprise:
receiving an evacuation call from a second evacuation floor; and
moving the first compartment to the second evacuation floor when the first door has closed and the remaining capacity within the first compartment is greater than zero.

16. The controller of claim 10, wherein the operations further comprise:
receiving an evacuation elevator call from a padding floor; and
moving the first compartment to the padding floor when the first door has closed and the remaining capacity within the first compartment is greater than zero.

17. The controller of claim 10, wherein the operations further comprise:
receiving an evacuation call from a second evacuation floor; and
moving at least one of the first compartment and the second compartment to the second evacuation floor when the first door has closed;
wherein the compartment moved to the second evacuation floor has a remaining capacity greater than zero.

18. The controller of claim 10, wherein the operations further comprise:
receiving an evacuation elevator call from a padding floor; and
moving at least one of the first compartment and the second compartment to the padding floor when the first door has closed;
wherein the compartment moved to the padding floor has a remaining capacity greater than zero.

19. A computer program product tangibly embodied on a computer readable medium, the computer program product including instructions that, when executed by a processor, cause the processor to perform operations comprising:
receiving an evacuation call from a first evacuation floor;
moving a first compartment of a multi-compartment elevator car to the first evacuation floor;
opening a first door of the first compartment when the first compartment arrives at the first evacuation floor;
monitoring, using a first sensor system, a remaining capacity within the first compartment; and
closing the first door when at least one of a first selected period of time has passed and the remaining capacity within the first compartment is equal to a first selected remaining capacity.

20. The computer program of claim 19, wherein the operations further comprise:
receiving an evacuation call from a second evacuation floor; and
moving at least one of the first compartment and the second compartment to the second evacuation floor when the first door has closed;
wherein the compartment moved to the second evacuation floor has a remaining capacity greater than zero.
